(19) United States
(12) Patent Application Publication
(10) Pub. No.: US 2004/0268373 A1
(43) Pub. Date: Dec. 30, 2004

(54) Tilt drive optical pickup actuator and optical recording and/or reproducing apparatus using the same and method

(75) Inventors: Byung-youn Song, Suwon-si (KR); Dae-jong Jang, Anyang-si (KR); Won-ik Cho, Seoul (KR); Jong-ha Jun, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/765,127

(22) Filed: Jan. 28, 2004

(30) Foreign Application Priority Data
Jan. 29, 2003 (KR) 2003-5926
Aug. 30, 2003 (KR) 2003-60550

(51) Int. Cl. G11B 7/00

(52) U.S. Cl. 720/683; 369/44.15; 369/44.22

(57) ABSTRACT

An optical pickup actuator including a lens holder holding an objective lens and which is supported by a suspension to be movable with respect to a base, and a magnetic circuit which drives the objective lens, and an optical recording and/or reproducing apparatus using the same. The magnetic circuit includes a pair of unipolar magnetized magnets positioned on the base to face each other, a focusing coil positioned in the lens holder to be placed between the pair of unipolar magnetized magnets, a plurality of tracking coils positioned at a side of the focusing coil facing the unipolar magnetized magnet, and a plurality of tilt coils, which, are positioned in an upper portion and/or a lower portion of the focusing coil with respect to an upper direction and a lower direction of a central axis of the objective lens.

### CROSS-REFERENCE TO RELATED APPLICATIONS

This application claims the benefit of Korean Patent Application Nos. 2003-5926, filed on Jan. 29, 2003 and 2003-60550, filed on Aug. 30, 2003, in the Korean Intellectual Property Office, the disclosures of which are hereby incorporated by reference.

### BACKGROUND OF THE INVENTION

1. Field of the Invention

The present invention relates to an optical pickup actuator and an optical recording and/or reproducing apparatus using the same, and more particularly, to a tilt drive optical pickup actuator that can be manufactured at a low cost by having a reduced number of magnets, and an optical recording and/or reproducing apparatus using the same.

2. Description of the Related Art

An optical pickup is a device, which is used in an optical recording and/or reproducing apparatus, and moves in a radial direction of an optical disc as an optical recording medium to record and/or reproduce information on and/or from the optical disc in a noncontact manner.

The optical pickup requires an actuator, which drives an objective lens in a tracking direction, a focusing direction and/or a tilt direction so that light emitted from a light source is formed as a light spot in an appropriate position on an optical disc. The pickup is driven in the tracking direction to adjust the objective lens in a radial direction of the optical disc so that the light spot is formed at the center of a track.

Basically, an optical pickup actuator drives the lens in both the tracking direction and the focusing direction, that is, two-axis driving. In recent years, a numerical aperture (NA) of the objective lens has been increased to assist in an implementation of a high-density optical storage apparatus, and consequently the wavelength of a laser light source is reduced. As such, a permissible tilting direction error margin of the optical pickup actuator is reduced. To compensate for this drawback, conventional actuators in addition to two-axis driving, that is, driving in both the focusing direction and the tracking direction, utilize a three-axis driving optical pickup actuator that is also driven in a tilt direction. In particular, driving in a radial direction of the optical disc is required. The three-axis driving optical pickup actuator that is driven in the focusing, tracking, and tilt directions is referred to as a tilt drive optical pickup actuator.

In general, the tilt drive optical pickup actuator has a four-sided structure using a magnetic circuit. The four-sided structure includes a magnetic circuit in which a driving coil and a magnet are arranged at each of the four sides of a lens holder.

FIG. 1 is a plan view showing a conventional tilt drive optical pickup actuator. Referring to FIG. 1, the conventional tilt drive optical pickup actuator includes a lens holder 2 on which an objective lens 1 is mounted, and a plurality of wires 6. One end of each of the wires 6 is connected to the lens holder 2 and the other end is fixed in a holder 3 placed on a base (not shown) so that a movable portion including the lens holder 2 moves in a focusing direction F and a tracking direction T with respect to the base The four-sided structure uses a magnetic circuit for driving the movable portion.

Four wires 6a serve as suspension wires to support the movable portion with respect to the base. Only two of the four wires 6a are shown in FIG. 1. In FIG. 1, reference numeral 6b denotes a wire that is used as a current applying path for driving in a tilting direction.

A conventional magnetic circuit includes a pair of focusing coils 4a and 4b that are positioned at both ends of the lens holder 2 in a radial direction of an optical disc, and a pair of tracking coils 4c and 4d that are positioned at both sides of the lens holder 2 in a tangential direction of the optical disc. Magnets 5a, 5b, 5c, and 5d generate an electromagnetic force that is used to drive the movable portion due to an interaction with current flowing through the focusing coils 4a and 4b and the tracking coils 4c and 4d. The circuit also includes a plurality of yokes 8.

In the conventional tilt drive optical pickup actuator, upon application of current to the focusing coils 4a and 4b and the tracking coils 4c and 4d, due to an interaction between the current flowing through the focusing coils 4a and 4b and the tracking coils 4c and 4d and magnetic flux generated in the magnets 5a, 5b, 5c, and 5d, an electromagnetic force acts on the focusing coils 4a and 4b and the tracking coils 4c and 4d. Consequently, a movable portion moves in a focusing direction and a tracking direction. As such, the objective lens 1 held in the lens holder 2 moves in the focusing direction and the tracking direction.

In addition, when current is applied to the pair of focusing coils 4a and 4b so that an electromagnetic force acts on each of the pair of focusing coils 4a and 4b in an opposite direction, the movable portion including the lens holder moves in a radial tilt direction, and the objective lens 1 held in the lens holder 2 moves in the radial tilt direction.

Since an electromagnetic force acts in a direction that is parallel to a central axis of the objective lens 1, the magnets 5a and 5b and the coils 4a and 4b are used to drive the lens holder 2 in both the focusing direction and the tilt direction. In other words, when currents of equal magnitude and direction are applied to each of the pair of focusing coils 4a and 4b, a focusing movement having a predetermined displacement occurs. When currents of the same magnitude, but opposite directions are applied to the pair of focusing coils 4a and 4b, tilt movement occurs.

However, the conventional tilt drive optical pickup actuator with a four-sided structure has a magnetic circuit in which the four coils 4a, 4b, 4c, and 4d are wound previously and separately positioned at each of the four sides of the lens holder 2 and requires four separate magnets 5a, 5b, 5c, and 5d. Because of the requirement for the four separate magnets 5a, 5b, 5c, and 5d and the four separate coils 4a, 4b, 4c, and 4d, the number of components and manufacturing costs are increased, and productivity decreased.

To incorporate previously-wound coils, a process of separately winding the coils and a process of attaching the wound coils to the lens holder are required. Thus the number of manufacturing processes increases, and a rate of defects occurring during the processes is higher than a process of directly winding the coils on the apparatus.

In addition, in the conventional tilt drive optical pickup actuator, magnets are positioned to face each of the four sides of the lens holder 2, and the focusing coils and the tracking coils are placed at each of the four sides of the lens holder 2, respectively. As a result, wiring between coils is complicated.

### SUMMARY OF THE INVENTION

Accordingly, it is an aspect of the present invention to provide a tilt drive optical pickup actuator that includes an inexpensive magnetic circuit that in addition to driving a lens in both a focusing direction and a tracking direction drives the lens in a tilt direction using two unipolar magnetized magnets, and an optical recording and/or reproducing apparatus using the same.

According to an aspect of the present invention, an optical pickup actuator includes a lens holder holding an objective lens and supported by a suspension to be movable with respect to a base. A magnetic circuit, which drives the objective lens, includes a pair of unipolar magnetized magnets, which are fixed in the base to face each other, and a focusing coil, which is positioned in the lens holder between the pair of unipolar magnetized magnets. The circuit also includes a plurality of tracking coils each positioned at a side of the focusing coil facing the unipolar magnetized magnet, and a plurality of tilt coils, which, when a central axis direction of the objective lens is an upper and lower direction with respect to the base, are positioned in an upper portion and/or a lower portion of the focusing coil.

According to an aspect of the present invention, the optical pickup actuator has a symmetric structure in which the pair of unipolar magnetized magnets are fixedly positioned to the base to face both sides of the lens holder. The focusing coil is wound around the lens holder, and the tracking coils are each positioned at a side of the lens holder facing one of the unipolar magnetized magnets, and the tilt coils are positioned at an upper portion and/or a lower portion of the lens holder.

According to an aspect of the present invention, the tracking coils are each wound on a plurality of reels formed in the lens holder, or the tracking coils are separately attached to the lens holder. A reel is formed at both sides of the lens holder in a radial direction of the objective lens on the upper portion and/or the lower portion of the lens holder. The tilting coils are each wound on one of a pair of reels in the upper portion and/or the lower portion of the lens holder.

According to an aspect of the present invention, an installation portion for the objective lens is formed in the lens holder, and spaced from the tilt coils that are arranged in the upper portion of the lens holder such that an effect of heat on the objective lens is reduced.

According to an aspect of the present invention, at least one thermal transfer blocking hole is formed in the lens holder to reduce an effect of heat transferred to the objective lens from heat generated in the focusing coil, the tracking coils and/or the tilt coils.

According to another aspect of the present invention, the optical pickup actuator has an asymmetric structure in which the objective lens is positioned on one side of the lens holder, and the pair of unipolar magnetized magnets are fixed to the base to face each other at one side of the objective lens. A coil assembly including the focusing coil, the tracking coils, and the tilt coils is positioned on the lens holder between the unipolar magnetized magnets.

According to an aspect of the present invention, the coil assembly includes a bobbin in which at least the focusing coil is aligned and wound.

A reel may also be formed in the bobbin to wind the tracking coils.

According to an aspect of the present invention, a reel is formed at both sides of the bobbin in a radial direction of the objective lens on the upper portion and/or the lower portion of the bobbin, and the tilt coils are wound on a pair of reels formed in the upper portion and/or the lower portion of the bobbin.

Alternatively, the coil assembly may use bulk type coils in which the focusing coil, the tracking coils, and the tilt coils are previously wound, and the coil assembly has the tracking coils and the tilt coils attached to the focusing coil. The optical pickup actuator further includes a bridge positioned above the magnetic circuit to guide a magnetic flux.

The optical pickup actuator further includes a pair of external yokes, which extend from the bridge and support the pair of unipolar magnetized magnets, and/or a pair of internal yokes, which are arranged inside the tilt coils of the coil assembly.

Alternatively, the optical pickup actuator includes a pair of external yokes on the base and on which the unipolar magnetized magnets are mounted, and/or a pair of internal yokes on the base to be placed inside the a respective tilting coil.

According to an aspect of the present invention, the tracking coils are positioned nearer the unipolar magnetized magnets than the focusing coil. Alternatively, the focusing coil is positioned nearer the unipolar magnetized magnets than the tracking coils.

According to another aspect of the present invention, an optical pickup actuator includes a lens holder holding an objective lens that is mounted and supported by a suspension to be movable with respect to a base. A magnetic circuit drives the objective lens. The actuator has an asymmetric structure in which the magnetic circuit includes a pair of unipolar magnetized magnets, which are positioned on the base to face each other on one side of the objective lens. A coil assembly, including a pair of focusing coils, is positioned in the lens holder between the pair of unipolar magnetized magnets and arranged to intersect a direction in which the pair of unipolar magnetized magnets are arranged. At least one of a plurality of tracking coils are positioned on at least one side of the focusing coils to face the unipolar magnetized magnets. The coil assembly is positioned on the lens holder between the pair of unipolar magnetized magnets.

The coil assembly uses bulk type coils in which the focusing coils and the tracking coils are previously wound. The coil assembly has a structure in which at least one of a plurality of tracking coils are attached to each one of the pair of focusing coils.

According to another aspect of the present invention, an optical recording and/or reproducing apparatus includes an optical pickup with an actuator to drive an objective lens positioned to be movable in a radial direction of an optical information storage medium. The apparatus records and/or reproduces information on and/or from the optical information storage medium, and a controller controls focusing and tracking servos of the optical pickup. The actuator includes a lens holder on which an objective lens is positioned and supported by a suspension to be movable with respect to a base. A magnetic circuit, which includes a pair of unipolar magnetized magnets, which are positioned on the base to face each other, and a focusing coil, which is positioned in the lens holder between the pair of unipolar magnetized magnets. At least one of each of a plurality of tracking coils are positioned by a side of the focusing coil facing the unipolar magnetized magnet. The circuit further includes a plurality of tilt coils, which, when a central axis direction of the objective lens is an upper and lower direction with respect to the base, are positioned in an upper portion and/or a lower portion of the focusing coil. The magnetic circuit drives the objective lens.

The optical pickup actuator has a symmetric structure in which the each of the pair of unipolar magnetized magnets is positioned on the base to face a different side of the lens holder. The focusing coil is wound around the lens holder, and the tracking coils are positioned at a side of the lens holder facing the unipolar magnetized magnet and the tilt coils are positioned on the upper portion and/or the lower portion of the lens holder.

Alternatively, the optical pickup actuator has an asymmetric structure in which the objective lens is positioned on one side of the lens holder, and the pair of unipolar magnetized magnets are positioned on the base to face each other at one side of the objective lens. A coil assembly includes the focusing coil, the tracking coils, and the tilt coils and is positioned on the lens holder to between the unipolar magnetized magnets.

According to another aspect of the present invention, an optical recording and/or reproducing apparatus includes an optical pickup having an actuator to drive an objective lens positioned to be movable in a radial direction of an optical information storage medium. The apparatus records and/or reproduces information on and/or from the optical information storage medium, and a controller controls focusing and tracking servos of the optical pickup. The actuator has an asymmetric structure in which a lens holder is positioned on an objective lens and is supported by a suspension to be movable with respect to a base. A magnetic circuit includes a pair of unipolar magnetized magnets positioned on the base to face each other at one side of the objective lens, and a coil assembly including a pair of focusing coils, which are positioned in the lens holder between the pair of unipolar magnetized magnets and are arranged to intersect a direction in which the pair of unipolar magnetized magnets are arranged. The circuit also includes a plurality of tracking coils, positioned on at least one side of the focusing coils facing the unipolar magnetized magnet. The coil assembly is positioned on the lens holder between the pair of unipolar magnetized magnets and drives the objective lens.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the invention will become apparent from the following description of the embodiments, taken in conjunction with the accompanying drawings in which:

FIG. 1 is a plan view schematically showing a conventional optical pickup actuator;

FIG. 2 is a perspective view schematically showing an optical pickup actuator according to an aspect of the present invention;

FIG. 3 is a perspective view of a lens holder of FIG. 2;

FIG. 4 is a plan view of FIG. 2;

FIG. 5 is a cross-sectional view taken along line A-A of FIG. 2;

FIG. 6 shows a magnetic circuit of an optical pickup actuator corresponding to FIG. 5, according to another aspect of the present invention;

FIG. 7 shows a magnetic circuit of an optical pickup actuator corresponding to FIG. 5, according to another aspect of the present invention;

FIG. 8 schematically shows a lens holder of an optical pickup actuator according to another aspect of the present invention;

FIG. 9 is a perspective view of an asymmetric optical pickup actuator according to another aspect of the present invention;

FIG. 10 is an exploded perspective view of FIG. 9;

FIG. 11 is a side view taken along line XI-XI of FIG. 9;

FIG. 12 is an exploded perspective view of a top cover and a base of FIG. 9;

FIG. 13 is an exploded perspective view of another example of a top cover and a base of an optical pickup actuator according to another aspect of the present invention;

FIG. 14 is a perspective view of another example of a base of an optical pickup actuator according to another aspect of the present invention;

FIG. 15 is an exploded perspective view of another example of an asymmetric optical pickup actuator according to another aspect of the present invention;

FIG. 16 is an exploded perspective view of an asymmetric optical pickup actuator according to another aspect of the present invention; and

FIG. 17 schematically shows a structure of an optical recording and/or reproducing apparatus using the optical pickup actuator according to an aspect of the present invention.

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below to explain the present invention by referring to the figures.

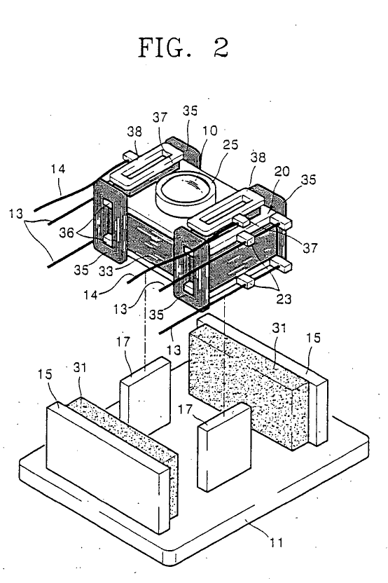

An optical pickup actuator according to an aspect of the present invention, as shown in FIGS. 2, 9, 15, and 16, is characterized by a magnetic circuit focusing, tracking, and tilt servos of the optical pickup actuator using a pair of unipolar magnetized magnets.

The magnetic circuit of the optical pickup actuator according to an aspect of the present invention, as shown in FIGS. 2, 9, and 15, includes a pair of unipolar magnetized magnets, a focusing coil, a plurality of tracking coils positioned at both sides of the focusing coil, and a plurality of tilt coils which, when a central axis direction of an objective lens is an upper and lower direction, are positioned in an upper portion and/or a lower portion of the focusing coil.

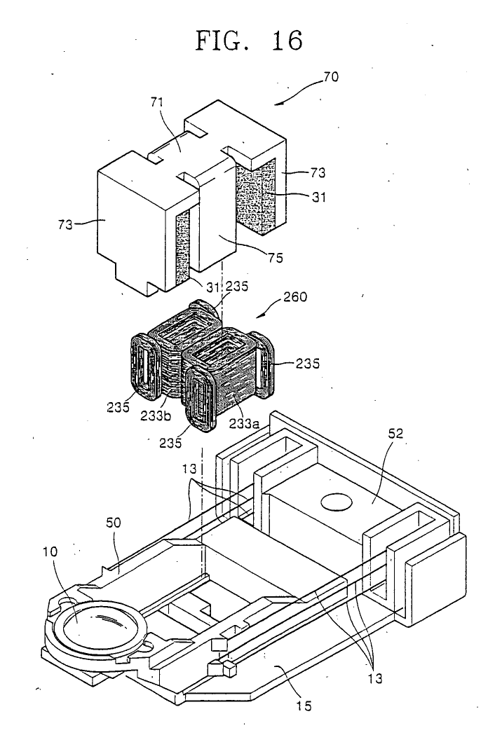

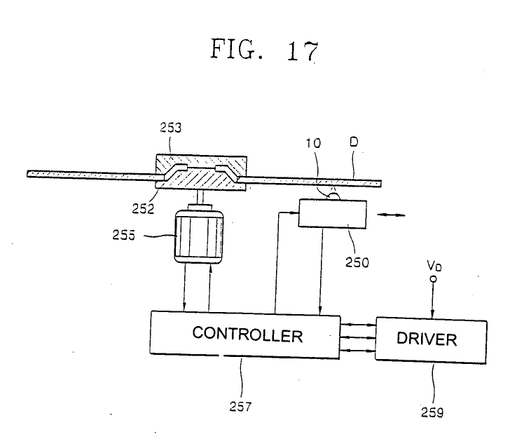

In addition, the magnetic circuit of the optical pickup actuator according to an aspect of the present invention, as shown in FIG. 16, includes a pair of unipolar magnetized magnets, a pair of focusing coils positioned to be at least partially between the unipolar magnetized magnets, and a plurality of tracking coils positioned on both sides of the pair of focusing coils.

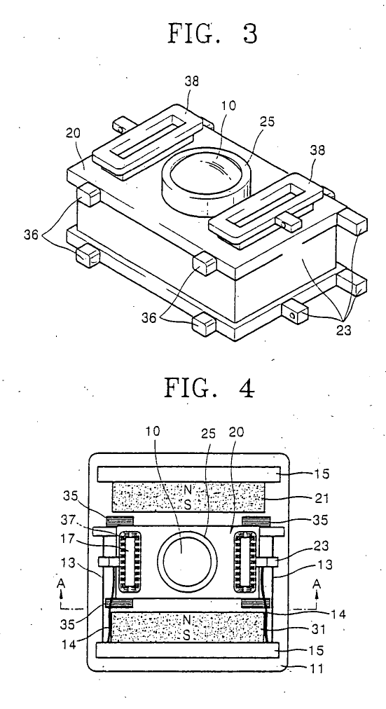

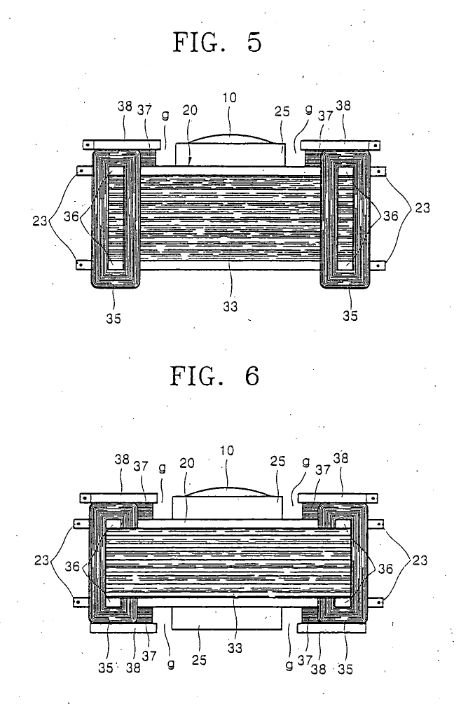

FIG. 2 is a perspective view schematically showing an optical pickup actuator according to an aspect of the present invention, FIG. 3 is a perspective view of a lens holder of FIG. 2, FIG. 4 is a plan view of FIG. 2, and FIG. 5 is a cross-sectional view taken along line A-A of FIG. 4.

Referring to FIGS. 2 through 5, the optical pickup actuator according to an aspect of the present invention has a symmetric structure including an objective lens 10 is positioned on a lens holder 20, and suspension wires 13 each having one end connected to the lens holder 20, and the other end thereof is fixed in a holder (not shown) positioned on one side on the base 11. The base supports the lens holder 20 to be movable with respect to the base 11, and a magnetic circuit is positioned in the lens holder 20 and the base 11.

In addition, the magnetic circuit includes a pair of unipolar magnetized magnets 31 that are positioned on the base 11 to face opposing sides of the lens holder 20 and parallel to a radial direction of an optical recording medium. A focusing coil 33 is wound around the lens holder 20, and a plurality of tracking coils 35 are positioned on sides of the lens holder 20 to face the unipolar magnetized magnets 31. A plurality of tilt coils 37 are positioned on an upper portion of the lens holder 20. The pair of unipolar magnetized magnets 31 are positioned on the base 11 to face opposing sides of the lens holder 20 in a tangential direction of an optical disc, which is an optical information storage medium.

According to an aspect of the present invention, four suspension wires 13 are also used as current applying wires for tracking control and focusing control. In addition to the four suspension wires 13, the optical pickup actuator according to an aspect of the present invention further includes two wires 14 to apply a tilting drive current.

The optical pickup actuator according to an aspect of the present invention has, in addition to the pair of unipolar magnetized magnets 31, a reel formed in the lens holder 20 so that at least a part of a coil is directly wound on the reel in the lens holder 20.

FIGS. 2 through 5 show a focusing coil directly wound on a body of the lens holder 20. Tracking coils 35 and tilting coils 37 are directly wound on reels 36 and 38, respectively formed in the lens holder 20.

The focusing coil 33 is wound around the lens holder 20 so that due to interaction with the pair of unipolar magnetized magnets 31, an electromagnetic force used to move the movable portion of the actuator in the focusing direction is generated.

The body of the lens holder 20 is formed as a reel structure so that the focusing coil 33 is directly wound around the lens holder 20. Alternatively, the winding position of the focusing coil 33 is defined by projections 23 for the suspension wires 13 and/or the reel 36 that is used for winding the tracking coils 35.

When a central axis direction of the objective lens 10 is an upper and lower direction with respect to the base, that is, a focusing direction, a side of the lens near the optical information storage medium is referred to as an upper side and an opposite side thereof is a referred to as lower side. Due to a magnetic field generated in the unipolar magnetized magnets 31, an electromagnetic force acts on the focusing coil 33 in the upper and lower directions, in accordance with Flemings Left Hand Rule, according to the direction of current flowing through the focusing coil 33 and the direction of magnetic flux generated in the unipolar magnetized magnets 31. As such, the movable portion of the optical pickup actuator according to an aspect of the present invention moves in the focusing direction.

As shown in FIGS. 2 through 5, reels 36 are formed on the lens holder 20 so that the tracking coils 35 are positioned on both sides of the lens holder 20 and face the unipolar magnetized magnets 31, and so that the tracking coils 35 are directly wound on the reels 36. Parts of the tracking coils 35 face a front side of the unipolar magnetized magnets 31 so that due to interaction with the unipolar magnetized magnets 31, an electromagnetic force to control movement in the tracking direction is generated. In addition, preferably, as shown in FIG. 2, a pair of the tracking coils 35 and a pair of the reels 36 that are used to wind the tracking coils 35 are provided at both sides of the lens holder 20 parallel to the radial direction of the optical recording medium so that the movable portion of the actuator moves in the tracking direction stably. In other words, preferably, four tracking coils 35 are provided.

FIGS. 2 through 5 show the tracking coils 35 wound outside the focusing coil 33. As shown in FIGS. 2 through 5, when the tracking coils 35 are wound outside the focusing coil 33, the tracking coils 35 are positioned nearer the unipolar magnetized magnets 31 resulting in heightened tracking sensitivity.

Alternatively, as shown in FIG. 6, the optical pickup actuator is configured with the focusing coil 33 wound outside the tracking coils 35 and the focusing coil positioned nearer the unipolar magnetized magnets 31. When the focusing coil 33 is wound outside the tracking coils 35, focusing sensitivity is improved. A structure in which the focusing coil 33 is wound outside the tracking coils 35 alternatively applied to aspects of the present invention shown in FIGS. 2 through 5 and FIG. 7 that will be described later.

According to an aspect of the present invention, as shown in FIGS. 2 through 5, a plurality of reels 38 are formed in the lens holder 20, and the tilt coils 37 are directly wound on the reels 38.

FIGS. 2 through 5 show reels 38 formed on both sides of the objective lens 10 in the radial direction of the optical recording medium. The movable portion of the actuator is driven in a radial tilting direction by the pair of tilt coils 37.

According to aspects of the present invention, as shown in FIGS. 2 through 5, reels 38 are formed on both sides of an upper portion of the lens holder 20 in a radial direction of the objective lens 10. The reels 38 are also formed so that both portions of the tilt coils 37, wound on the respective reels 38, face the pair of unipolar magnetized magnets 31 and are effective. The tilting coils 37 are wound parallel to the focusing coil 33.

According to an aspect of the present invention, each of the pair of tilt coils 37 in the upper portion of the lens holder 20 is wound in an opposite direction. Thus, when the same current is applied to the pair of tilt coils 37, the directions of current flows through each of the pair of tilt coils 37 is opposite. As such, considering the directions of current flowing through the pair of tilting coils 37 and the direction of magnetic flux generated in the unipolar magnetized magnets 31, an electromagnetic force is generated in opposite up and down directions in accordance with Flemings Left Hand Rule such that the movable portion moves in the tilt direction.

Thus, when the reels 38 are positioned in this manner and the tilt coils 37 are wound on the reels 38, due to an interaction between the pair of unipolar magnetized magnets 31 and the pair of tilt coils 37 that are arranged at both sides of the objective lens 10 in the tangential direction, the movable portion of the actuator is stably driven in the radial tilt direction.

When reels 38 are formed in the upper portion of the lens holder 20 and the tilt coils 37 are placed in the upper portion of the lens holder 20, the objective lens 10 is positioned in the upper portion of the lens holder 20. Thus, the radial tilt driving force is centered near the objective lens 10 such that during tilt, interference in the focusing movement is decreased.

When the reels 36 and 38 are formed in the lens holder 20, so that alignment winding is performed, and the focusing coil 33, the tracking coils 35 and/or the tilt coils 37 are directly wound on the lens holder 20, the reels 36 and 38 serve as guides to suppress coil deformation upon an excessive current flowing through one of the coils.

As described above, the optical pickup actuator according to an aspect of the present invention including the magnetic circuit shown in FIGS. 2 through 5 is a three-axis drive actuator which includes two unipolar magnetized magnets 31, the lens holder 20 in which alignment winding is performed, two tilt coils 37, one focusing coil 33, and four tracking coils 35.

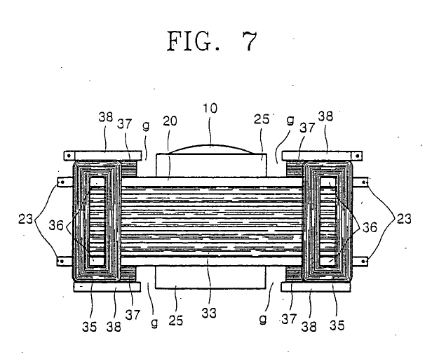

Referring to FIG. 7 which schematically shows the optical pickup actuator according to another aspect of the present invention, the optical pickup actuator has a structure in which the reels 38 used to wind the tilt coils 37 are formed on both sides of the lens holder 20 in a radial direction of the objective lens 10 on the lower portion of the lens holder 20. In other words, the optical pickup actuator has a structure in which two of the tilt coils 37 are arranged in the radial direction in each of an upper and lower portion of the lens holder 20. The portion of the holder occupied by the focusing coil 33 is reduced so that the overall height of the optical pickup actuator is the same as other aspects of the present invention.

As shown in FIG. 7, if the pair of tilt coils 37 for radial tilt driving are provided in the lower portion of the lens holder 20, a radial tilt driving force is increased.

The optical pickup actuator shown in FIG. 7 is a three-axis drive actuator which includes two unipolar magnetized magnets 31, a lens holder 20 in which alignment winding is performed, four tilt coils 37, one focusing coil 33, and four tracking coils 35.

Meanwhile, as shown in FIGS. 2 through 7, an installation portion 25 holding the objective lens 10 so as to protrude from the upper portion is formed in the lens holder 20. A predetermined gap g is between the installation portion 25, and each of the pair of reels 38 in the upper portion of the lens holder 20 and the tilt coils 37 wound on the reels 38. According to an aspect of the invention, as shown in FIG. 7, when the tilt coils 37 are also wound on reels 38 in a lower portion of the lens holder 20, the gap g is also between the installation portion 25 of the objective lens 10 in the lower portion of the lens holder 20 and the reels 38.

When the tilt coils 37 and the installation portion 25 are spaced apart and the tilt coils 37 do not contact the installation portion 25 during tilt control, a potential effect of heat, generated by current applied to the tilt coils 37, on the objective lens 10 is reduced such that the objective lens 10 is protected from excessive current. When the installation portion 25 and the tilt coils 37 are spaced apart, the distance for thermal transfer is lengthened and thermal transfer speed decreased.

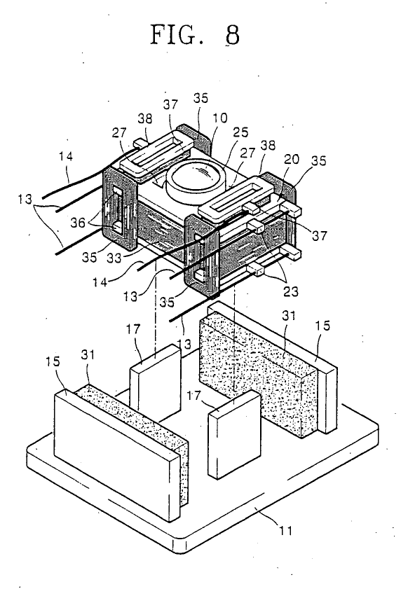

Additionally, as shown in FIG. 8, at least one thermal transfer blocking hole 27 is formed in the lens holder 20, to further decrease the thermal transfer. FIG. 8 shows a case where the thermal transfer blocking hole 27 is formed between the reels 38 for winding the tilt coils 37 and the installation portion 25 of the objective lens 10. The thermal transfer blocking hole 27 is alternatively applied to aspects of the present invention shown in FIGS. 2, 6, and 7.

The thermal transfer blocking hole 27 may be formed open to the surface of the holder 10 or as a cavity within a wall of the holder 10 (not shown) within the range of rigidity required in the lens holder 20.

According to an aspect of the present invention, as shown in FIGS. 2 and 4, the above-described optical pickup actuator further includes a pair of external yokes 15 positioned on the base 11 and/or a pair of internal yokes 17 positioned on the base 11 between the external yokes 15.

The unipolar magnetized magnets 31 are positioned next to the external yokes 15. As shown in FIG. 4, the internal yokes 17 are positioned inside the tilt coils 37 so that they are commonly applied to the focusing coil 33, the tracking coils 35, and the tilt coils 37.

As described above, the optical pickup actuator according to an aspect of the present invention has a structure in which both the tracking coils 35 and the tilt coils 37 are directly wound on the lens holder 20. However, aspects of the present invention are not limited to this structure. In other words, the optical pickup actuator according to an aspect of the present invention has a structure in which one of the tracking coils 35 and one of the tilt coils 37 are directly wound on the lens holder 20 and the other coils are previously-wound bulk-type coils and are attached to the lens holder 20.

In addition, the optical pickup actuator according to an aspect of the present invention has a structure in which the bulk-type tracking coils 35 and tilting coils 37 are previously wound, and subsequently are attached to the lens holder 20.

According to an aspect of the present invention, even when the bulk-type tilting coils 37 are attached to the lens holder 20, the tilt coils 37 are attached to the upper portion of the lens holder 20 spaced apart from the installation portion 25 so that the effect of heat, generated in the tilt coils 37, on the objective lens 10 is reduced.

Aspects of the present invention in which the reels 36 and/or the reels 38 are not formed in the lens holder 20, and the tracking coils 35 and/or the tilt coils 37 are bulk-type coils attached to the lens holder 20, can be sufficiently inferred from the previous descriptions of FIGS. 2 through 8. Thus, a description thereof will be omitted.

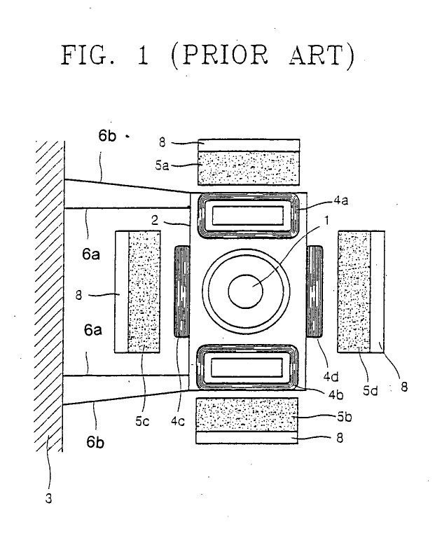

The above-described symmetric optical pickup actuator according to an aspect of the present invention has a two-sided structure using a magnetic circuit since the optical pickup actuator uses only two of the four sides of the lens holder 20 to arrange the magnetic circuit. The conventional optical pickup actuator previously described and shown in FIG. 1 uses all of the four sides of the lens holder 20 to arrange the magnetic circuit.

Although an aspect of the present invention in which the magnetic circuit is applied to a symmetric actuator in which the center of an objective lens is the center of the driving force, has been described and illustrated as above, the magnetic circuit according to another aspect the present invention is alternatively applied to an asymmetric actuator in which the center of the objective lens is not the center of the driving force.

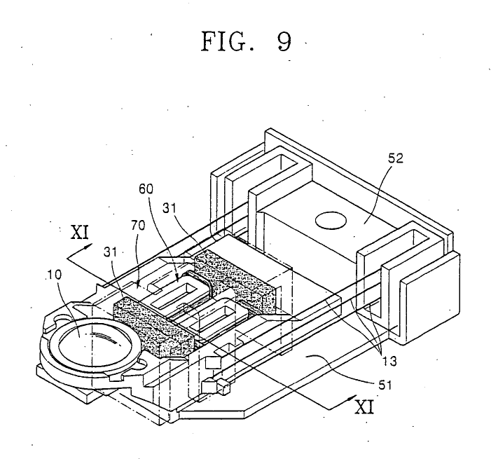

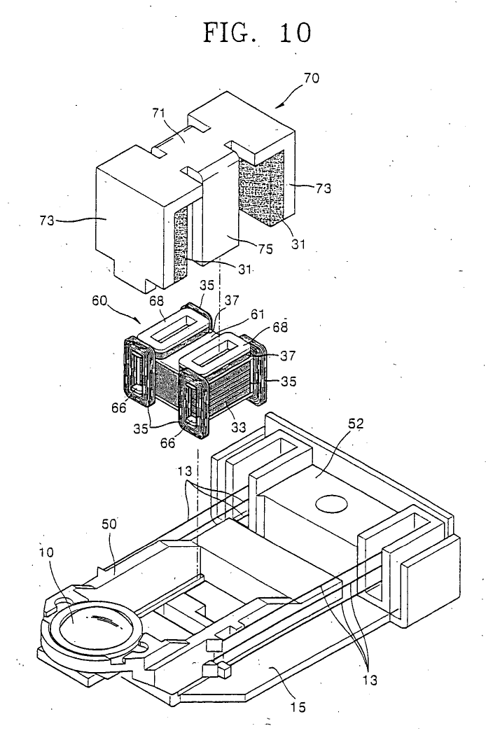

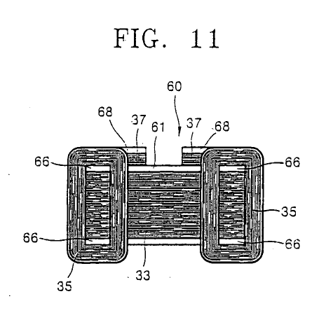

FIG. 9 is a perspective view of an asymmetric optical pickup actuator according to another aspect of the present invention. FIG. 10 is an exploded perspective view of FIG. 9. FIG. 11 is a side view taken along line XI-XI of FIG. 9.

Referring to FIGS. 9 through 11, the optical pickup actuator according to another aspect of the present invention has an asymmetric structure in which an objective lens 10 is mounted on one side of a lens holder 50, a pair of unipolar magnetized magnets 31 are positioned on a base 51 to face each other at one side of the objective lens 10, and a coil assembly 60 including a focusing coil 33, tracking coils 35, and tilt coils 37 is positioned on the lens holder 50 between the unipolar magnetized magnets 31. Holder 52 is positioned at one side of the base 51 and with one end of each of a plurality of suspension wires 13 fixed to the holder. As described previously, one end each of the suspension wires 13 is connected to the lens holder 20, and the other end thereof is fixed to the holder 52 so that the suspension wires 13 support the lens holder 50 to be movable with respect to the base 51.

Elements having substantially the same functions as those of the aspects of the present invention previously described refer to same reference numerals, and repeated descriptions thereof will be omitted.

According to an aspect of the present invention, the coil assembly 60 includes a bobbin 61 in which the focusing coil 33 is wound. The coil assembly 60 has a structure having at least the focusing coil 33 aligned and wound in the bobbin 61.

FIG. 10 shows a case where reels 66 for winding the tracking coils 35 and reels 68 for winding the tilt coils 37 are formed on the bobbin 61. Reels 68 are placed at both sides of the bobbin 61 in a radial direction of the objective lens 10 on an upper portion and/or a lower portion of the bobbin 61, and the tilt coils 37 are respectively wound in the reel 68. FIGS. 9 through 11 show a case where the reels 68 are formed on both sides of the bobbin 61 in a radial direction of the objective lens 10 on the upper portion of the bobbin 61 and the tilt coils 37 are wound on the reels 68. The reels 68 and the tilt coils 37 wound on the reels 68 are also provided in the lower portion of the bobbin 61, as shown in FIG. 7.

As shown in FIG. 10, when the reels 66 and 68 for winding the tracking coils 35 and the tilt coils 37, respectively, are formed on the bobbin 61, the tracking coils 35 and the tilt coils 37 as well as the focusing coil 33 are aligned and wound on the bobbin 61.

Comparing FIGS. 2, and 3 to FIG. 10, the bobbin 61 of the coil assembly 60 has substantially the same structure as a structure of the lens holder 20 of the aspects of the invention previously described other than the bobbin 61 not having the projections 23 for supporting the suspension wires 13 and the installation portion 25 for installing the objective lens 10. The relative arrangement relation between the focusing coil 33, the tracking coils 35, and the tilt coils 37 is substantially the same as the relative arrangements relation previously described.

Coil assembly 60 may have a structure in which the tracking coils 35 and the tilt coils 37 are directly wound on the bobbin, or alternatively one of the tracking coils 35 and the tilt coils 37 of the coil assembly 60 are directly wound on the bobbin 61 and the remaining coils are previously-wound bulk-type coils that subsequently are attached to the bobbin 61.

Alternatively, the coil assembly 60 has a structure in which the bulk-type tracking coils 35 and tilting coils 37 are previously wound and are attached to the bobbin 61.

Referring to FIGS. 10, 12, and 13, the optical pickup actuator according to another aspect of the present invention includes a top cover 70 or top cover 170 to guide magnetic flux.

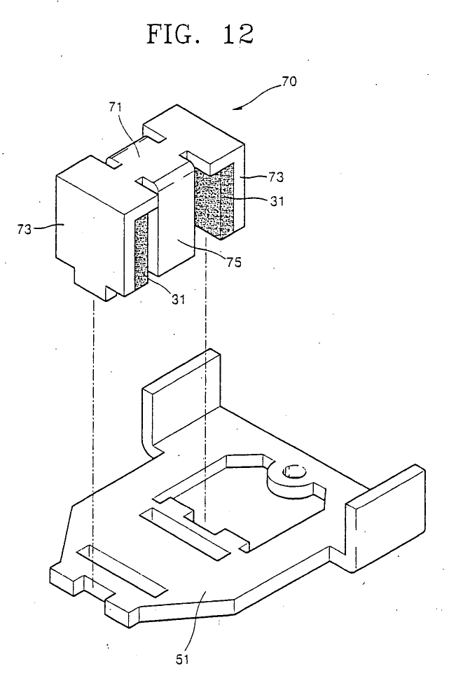

As shown in FIG. 12, the top cover 70 includes a bridge 71 positioned above a magnetic circuit and a pair of external yokes 73 and a pair of internal yokes 75, which extend from the bridge 71. A pair of unipolar magnetized magnets 31 are positioned inside the respective external yokes 73, and ends of the external yokes 73 are combinable with the base 51. According to an aspect of the present invention, the internal yokes 75 are positioned between the tracking coils 35, through the tilt coils 37, and are combinable with the base 51.

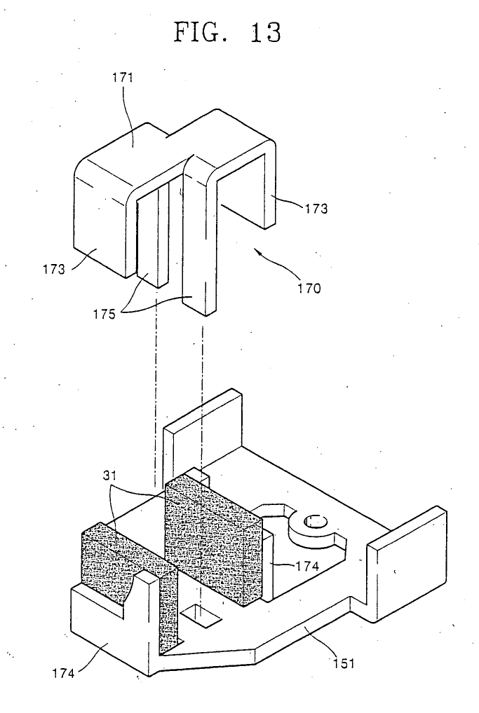

Alternatively, as shown in FIG. 13, the top cover 170 includes a bridge 171, a pair of internal yokes 175, and a pair of partial external yokes 173. In this case, when a pair of partial external yokes 174 combined with the partial external yokes 173 are provided in the base 151. The partial external yokes 174 extending from the base 151 support the unipolar magnetized magnets 31, and the partial external yokes 173 extending from the bridge 171 of the top cover 170 are combinable with the partial external yokes 174 of the base 151 to support the unipolar magnetized magnets 31. The internal yokes 175 of the top cover 170 are combinable with the base 151.

In addition, the top cover has a variety of modifications. That is, the top cover may alternatively comprise only a bridge and internal yokes. In this case, external yokes for mounting the unipolar magnetized magnets 31 are formed in the base.

According to another aspect of the present invention, the internal yokes are provided in the base, and the bridge and the external yokes in which the unipolar magnetized magnets 31 are fixable are provided in the top cover. The top cover is combinable with the base.

Regardless of the structure of the top cover, use of the top cover and the arrangement of the coil assembly 60 in a narrow space between the pair of unipolar magnetized magnets 31 improves control sensitivity.

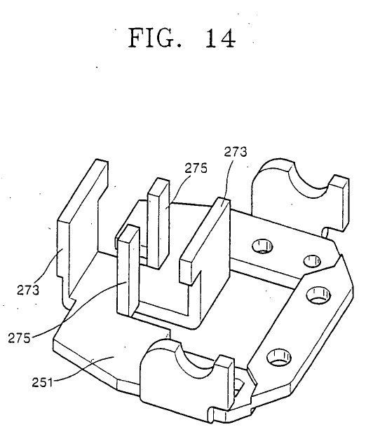

The optical pickup actuator according to another aspect of the present invention includes external yokes 273 and internal yokes 275 formed on a base 251, as shown in FIG. 14, instead of being formed in the above-described top cover.

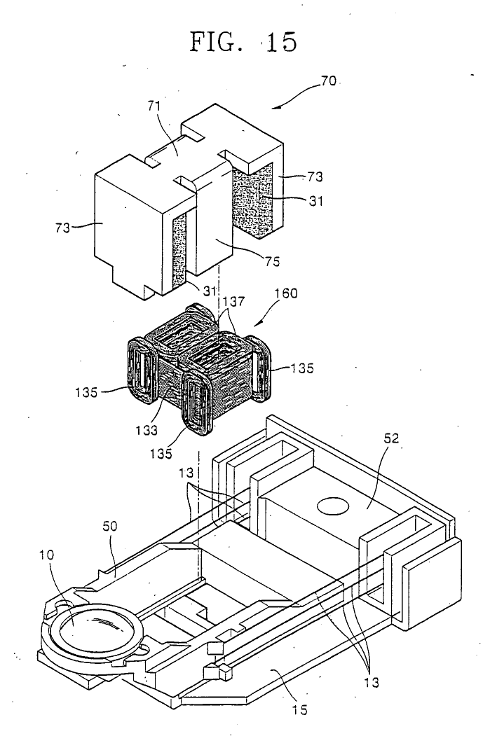

FIG. 15 is an exploded perspective view of another example of an asymmetric optical pickup actuator according to another aspect of the present invention. Comparing FIG. 15 with FIG. 10, in the example shown in FIG. 15, a coil assembly 160 is formed by attaching previously-wound bulk type coils to one another, and alignment winding in a bobbin is omitted. Parts other than the coil assembly 160 shown in FIG. 15 are the same as in the example shown in the structure of FIG. 10. In aspects of the present invention include possible variations to the top cover and/or base as previously described.

As shown in FIG. 15, the coil assembly 160 includes bulk type coils in which a focusing coil 133, tracking coils 135, and tilt coils 137 are previously wound. The coil assembly 160 has a structure in which the tracking coils 135 and the tilt coils 137 are attached to the focusing coil 133. The arrangement and functions of the focusing coil 133, the tracking coils 135, and the tilt coils 137 are substantially the same as those of the coil assembly 60 including the focusing coil 33, the tracking coils 35, and the tilt coils 37 shown in FIG. 10.

FIG. 16 is an exploded perspective view of an asymmetric optical pickup actuator according to another aspect of the present invention. The asymmetric optical pickup actuator includes a coil assembly 260 that includes a pair of focusing coils 233a and 233b between a pair of unipolar magnetized magnets 31, and a plurality of tracking coils 235 positioned on at least one side of the pair of focusing coils 233a and 233b facing the unipolar magnetized magnets 31. Tilting coils are omitted.

In FIG. 16, the coil assembly 260 has a structure in which alignment winding in a bobbin is omitted similar to the example shown in FIG. 15. That is, the coil assembly 260 includes bulk-type coils in which the focusing coils 233a and 233b and the tracking coils 235 are previously wound. The pair of focusing coils 233a and 233b are attached to one another and the tracking coils 235 are attached to the focusing coils 233a and 233b. The pair of internal yokes 75 formed in the top cover 70 are insertable in cavities defined by the focusing coils 233a and 233b.

The example shown in FIG. 16, other than the coil assembly 260, is similar to the example shown in FIG. 10. Aspects of the present invention include possible variations to the top cover and/or base as previously described.

FIG. 17 schematically shows an optical recording and/or reproducing apparatus using an optical pickup actuator according to an aspect of the present invention. Referring to FIG. 17, the optical recording and/or reproducing apparatus includes a spindle motor 255 to rotate an optical information storage medium, that is, an optical disc D, an optical pickup 250 which is positioned to be movable in a radial direction of the optical disc D and to record and/or reproduce information on and/or from the optical disc D, a driver 257 to drive the spindle motor 355 and the optical pickup 350, and a controller 370 to control focusing, tracking and/or tilt servos of the optical pickup 350. A turntable 252 and a clamp 253 to chuck the optical disc D are also included.

The optical pickup 250 includes an optical pickup optical system having an objective lens 10 to condense light emitted from a light source onto the optical disc D, and an optical pickup actuator to drive the objective lens 10 along three axes, according to aspects of the present invention. One of the optical pickup actuators according to aspects of the present invention described previously is suitable for use as the optical pickup actuator.

Light reflected from the optical disc D is detected through a photo detector provided to the optical pickup 250, photoelectrically transformed, and converted into an electrical signal. The electrical signal is input into the controller 259 through the driver 257. The driver 257 controls a rotational speed of the spindle motor 255, amplifies the input signal, and drives the optical pickup 250. The controller 259 transmits focusing servo, tracking servo, and tilt servo commands that are adjusted based on the signal input from the driver 257 back to the driver 257 so that focusing, tracking, and tilt operations of the optical pickup 250 are performed.

The above-described optical pickup actuator according to aspects of the present invention may be symmetrical or asymmetrical, and include unipolar magnetized magnets. In addition, the number of unipolar magnetized magnets is limited to two and three-axis driving is performed. As such, manufacturing costs are reduced. Also, the optical pickup actuator, according to aspects of the present invention has various widths including a slim-type optical pickup actuator. Costs are reduced because the magnetic circuit is configured with two low-priced unipolar magnetized magnets.

In addition, at least a part of a coil is directly wound on the lens holder or the bobbin such that a number of separate parts is reduced, and thus defect rates are reduced.

In addition, the optical pickup actuator according to aspects of the present invention provides optimal linearity. Linearity is reduced with an increase of a number of polarization areas applied onto one surface. This is because a zero magnetic flux is in a neutral zone that exists between polarization areas, and a resultant Lorentz force caused by the magnetic flux at a transient region varies closer to the neutral zone. The optical pickup actuator according to an aspect of the present invention uses unipolar magnetized magnets, and thus has excellent linearity.

In addition, in the symmetric optical pickup actuator according to an aspect of the present invention, a gap between an objective lens installation portion of a lens holder and a reel and/or at least one thermal transfer blocking hole is formed in the lens holder, such that the objective lens is protected from heat resulting from an excessive current.

Although a few embodiments of the present invention has been shown and described, it would be appreciated by those skilled in the art that changes may be made in these embodiments without departing from the principles and spirit of the invention, the scope of which is defined in the claims and their equivalents.

What is claimed is:

1. An optical pickup actuator for use with an objective lens on a base, comprising:
a lens holder holding the lens;
a suspension movingly supporting the lens holder so that the lens holder is movable with respect to the base; and
a magnetic circuit to drive the objective lens, wherein the magnetic circuit comprises:
a pair of unipolar magnetized magnets positioned on the base to face each other,
a focusing coil positioned in the lens holder between the pair of unipolar magnetized magnets,
a plurality of tracking coils, wherein each of the plurality of tracking coils is positioned at a side of the focusing coil facing one of the unipolar magnetized magnets, and
a plurality of tilt coils positioned in an upper portion and/or a lower portion of the focusing coil corresponding to an upper direction and a lower direction of a central axis of the objective lens.

2. The optical pickup actuator of claim 1, wherein the optical pickup actuator is symmetrically arranged and the pair of unipolar magnetized magnets are positioned on the base to face opposing sides of the lens holder, the focusing coil is wound around the lens holder, the tracking coils are positioned at a side of the lens holder facing the unipolar magnetized magnet, and the tilt coils are positioned in the upper portion and/or the lower portion of the lens holder.

3. The optical pickup actuator of claim 2, wherein the tracking coils are wound on a plurality of first reels formed in the lens holder to wind the tracking coils or the tracking coils are separately attached to the lens holder.

4. The optical pickup actuator of claim 2, further comprising a first reel formed at each opposing side of the lens holder in a radial direction of the objective lens on the upper portion and/or the lower portion of the lens holder, and the tilt coils are wound on each of the first reels.

5. The optical pickup actuator of claim 2, wherein an installation portion for installing the objective lens is formed in the lens holder spaced apart from the tilt coils in the upper portion of the lens holder such that an effect of heat generated by the focus coil, tracking coils and/or tilt coils on the objective lens is reduced.

6. The optical pickup actuator of claim 2, wherein at least one thermal transfer blocking hole is formed in the lens holder to reduce an effect of heat generated in the focusing coil, the tracking coils and/or the tilt coils on the objective lens.

7. The optical pickup actuator of claim 1, wherein the optical pickup actuator is asymmetrically arranged and the objective lens is positioned on one side of the lens holder, the pair of unipolar magnetized magnets are positioned on the base to face each other at one side of the objective lens, and the focusing coil, the plurality of tracking coils, and the plurality of tilt coils are in a coil assembly mountable on the lens holder to be positioned between the unipolar magnetized magnets.

8. The optical pickup actuator of claim 7, wherein the coil assembly further comprises a bobbin on which at least the focusing coil is aligned and wound.

9. The optical pickup actuator of claim 8, further comprising at least one second reel formed on the bobbin to wind the tracking coils.

10. The optical pickup actuator of claim 8, further comprising a second reel formed on each side of the bobbin in a radial direction of the objective lens on an upper portion and/or a lower portion of the bobbin, and the tilt coils are wound on each of the second reels.

11. The optical pickup actuator of claim 7, wherein the focusing coil, the tracking coils, and the tilt coils are bulk-type coils wound prior to assembly of the optical pickup actuator, and the tracking coils and the tilt coils are attached to the focusing coil in the coil assembly.

12. The optical pickup actuator of claim 7, further comprising a bridge placed above the magnetic circuit to guide a magnetic flux.

13. The optical pickup actuator of claim 12, further comprising at least one of a pair of external yokes extending from the bridge to support the pair of unipolar magnetized magnets and a pair of internal yokes positioned inside a cavity defined by walls of the tilt coils of the coil assembly.

14. The optical pickup actuator of claim 7, further comprising at least one of a pair of external yokes positioned on the base and on which the unipolar magnetized magnets are mountable, and a pair of internal yokes positioned on the base inside a cavity defined by walls of the tilt coils.

15. The optical pickup actuator of claim 7, wherein the tracking coils are positioned nearer the unipolar magnetized magnets than the focusing coil.

16. The optical pickup actuator of claim 7, wherein the focusing coil is positioned nearer the unipolar magnetized magnets than the tracking coils.

17. The optical pickup actuator of claim 1, further comprising at least one of a pair of external yokes positioned on the base and on which the unipolar magnetized magnets are mountable, and a pair of internal yokes positioned on the base inside a cavity defined by walls of the tilt coils.

18. The optical pickup actuator of claim 1, wherein the tracking coils are positioned nearer the unipolar magnetized magnets than the focusing coil.

19. The optical pickup actuator according to claim 1, wherein the focusing coil is positioned nearer the unipolar magnetized magnets than the tracking coils.

20. The optical pickup actuator according to claim 1, wherein the magnetic circuit includes only a single pair of unipolar magnetized magnets.

21. The optical pickup actuator according to claim 1, wherein the actuator is a two-sided, three axis driving pickup actuator.

22. An optical pickup actuator having an asymmetric structure for driving an objective lens positioned on a base, comprising:
a lens holder to hold the objective lens;
a suspension movingly supporting the lens holder so that the lens holder is movable with respect to the base; and
a magnetic circuit, wherein the magnetic circuit comprises:
a pair of unipolar magnetized magnets positioned on the base to face each other at one side of the objective lens, and
a coil assembly mountable on the lens holder between the pair of unipolar magnetized magnet, wherein the coil assembly comprises:
a pair of focusing coils positioned in the lens holder between the pair of unipolar magnetized magnets, and
a plurality of tracking coils positioned on at least one side of the pair of focusing coils to face the unipolar magnetized magnets.

23. The optical pickup actuator of claim 22, wherein the coil assembly uses bulk type coils in which the focusing coils and the tracking coils are previously wound, and the plurality of tracking coils are attached to the pair of focusing coils in the coil assembly.

24. The optical pickup actuator according to claim 22, wherein the magnetic circuit includes only a single pair of unipolar magnetized magnets.

25. The optical pickup actuator according to claim 22, wherein the actuator is a two-sided, three axis driving pickup actuator.

26. An optical recording and/or reproducing apparatus for recording and/or reproducing information from an optical information storage medium, comprising:
an optical pickup, wherein the optical pickup comprises:
an actuator positioned on a base to be movable in a radial direction of the optical information storage medium, and
a focusing servo and a tracking servo; and
a controller to control the focusing and tracking servos,
wherein the actuator comprises:
a lens holder holding an objective lens,
a suspension movingly support the lens holder so that the lens holder is movable with respect to the base, and
a magnetic circuit to drive the objective lens comprising:
a pair of unipolar magnetized magnets positioned on the base to face each other,
a focusing coil positioned in the lens holder between the pair of unipolar magnetized magnets,
a plurality of tracking coils, wherein each of the plurality of tracking coils is positioned at a side of the focusing coil facing the unipolar magnetized magnet, and
a plurality of tilt coils positioned in an upper portion and/or a lower portion of the focusing coil corresponding to an upper direction and a lower direction of a central axis of the objective lens.

27. The apparatus of claim 26, wherein the optical pickup actuator is symmetrically arranged and the pair of unipolar magnetized magnets are positioned on the base to face opposing sides of the lens holder, the focusing coil is wound around the lens holder, the tracking coils are positioned at a side of the lens holder facing the unipolar magnetized magnet, and the tilt coils are positioned in an upper portion and/or a lower portion of the lens holder.

28. The apparatus of claim 27, wherein the tracking coils are wound on a plurality of first reels formed on the lens holder or the tracking coils are separately attached to the lens holder

29. The apparatus of claim 27, further comprising a first reel formed at each opposing side of the lens holder in a radial direction of the objective lens on the upper portion and/or the lower portion of the lens holder, and the tilt coils are wound on each of the first reels.

30. The apparatus of claim 27, wherein at least one thermal transfer blocking hole is formed in the lens holder to reduce an effect of heat generated in the focusing coil, the tracking coils and/or the tilt coils on the objective lens.

31. The apparatus of claim 26, wherein the optical pickup actuator is asymmetrically arranged and the objective lens is positioned on one side of the lens holder, the pair of unipolar magnetized magnets are positioned on the base to face each other at one side of the objective lens, and the focusing coil, the tracking coils, and the tilt coils are positioned on the coil assembly to be positioned between the unipolar magnetized magnets.

32. The apparatus of claim 31, wherein the coil assembly further comprises a bobbin on which the focusing coil is aligned and wound.

33. The apparatus of claim 32, wherein at least one second reel is formed on the bobbin to wind the tracking coils.

34. The apparatus of claim 32, wherein a second reel is formed on each opposing side of the bobbin in a radial direction of the objective lens on an upper portion and/or a lower portion of the bobbin, and the tilt coils are wound on each of the second reels.

35. The apparatus of claim 31, wherein the coil assembly uses bulk type coils in which the focusing coil, the tracking coils, and the tilt coils are wound prior to assembly of the optical pickup actuator, and the tracking coils and the tilt coils are attached to the focusing coil in the coil assembly.

36. The apparatus of claim 31, further comprising a bridge positioned above the magnetic circuit to guide magnetic flux.

37. The apparatus of claim 36, further comprising at least one of a pair of external yokes extending from the bridge to support the pair of unipolar magnetized magnets and a pair of internal yokes positioned inside a cavity defined by walls of the tilt coils of the coil assembly.

38. The apparatus of claim 31, further comprising:
a bobbin, and
at least one of a pair of external yokes formed on the base and on which the unipolar magnetized magnets are positioned and a pair of internal yokes formed in the base to be insertable inside a cavity defined by walls of the bobbin.

39. The apparatus of claim 31, wherein the tracking coils are positioned nearer the unipolar magnetized magnets than the focusing coil.

40. The apparatus according to claim 31, wherein the focusing coil is positioned nearer the unipolar magnetized magnets than the tracking coils.

41. The apparatus of claim 26, further comprising:
a bobbin, and
at least one of a pair of external yokes formed on the base and on which the unipolar magnetized magnets are positioned and a pair of internal yokes formed in the base to be insertable inside a cavity defined by walls of the bobbin.

42. The apparatus of claim 26, wherein the tracking coils are placed nearer the unipolar magnetized magnets than the focusing coil,

43. The apparatus according to claim 26, wherein the focusing coil is placed nearer the unipolar magnetized magnets than the tracking coils.

44. The apparatus according to claim 26, wherein the magnetic circuit includes only a single pair of unipolar magnetized magnets.

45. The apparatus according to claim 26, wherein the actuator is a two-sided, three axis driving pickup actuator.

46. An optical recording and/or reproducing apparatus for recording and/or reproducing information from an optical information storage medium, comprising:
an optical pickup comprising:
an actuator for driving an objective lens positioned on a base to be movable in a radial direction of the optical information storage medium and
a focusing servo and a tracking servo; and
a controller to control the focusing and tracking servos,
wherein the actuator has an asymmetric structure and comprises:
a lens holder to hold the objective lens,
a suspension movingly supporting the lens holder so that the lens holder is movable with respect to the base, and
a magnetic circuit comprising:
a pair of unipolar magnetized magnets positioned on the base to face each other at one side of the objective lens, and
a coil assembly comprising:
a pair of focusing coils positioned in the lens holder between the pair of unipolar magnetized magnets arranged to intersect a direction in which the pair of unipolar magnetized magnets are arranged], and
a plurality of tracking coils positioned on at least one side of the focusing coils facing the unipolar magnetized magnet, and the coil assembly mountable on the lens holder between the pair of unipolar magnetized magnets, to drive the objective lens.

47. The apparatus of claim 46, wherein the coil assembly uses bulk type coils in which the focusing coils and the tracking coils are previously wound, and the the plurality of tracking coils are attached to the pair of focusing coils in the coil assembly.

48. A method to increase precision of control of a movable lens holder holding an objective lens of an optical pickup actuator, comprising:
controlling a direction of a magnetic flux generated in a pair of unipolar magnets;
controlling a direction of flowing current through each of a pair of tilt coils positioned in an upper portion of the lens holder; and
moving the movable lens holder,
wherein the tilt coils are wound in opposite directions and face the pair of unipolar magnets.

49. The method according to claim 48, wherein a first reel is formed on an upper portion of the objective lens holder in a radial direction of the objective lens.

50. The method according to claim 48, wherein the tilt coils are wound parallel to the focusing coils, and the moving the movable lens holder comprises driving the holder in a radial tilt direction.

51. The method according to claim 48, further comprising decreasing interference in a focusing movement by centering a radial tilt driving force near the objective lens.
